(19) United States
(12) Patent Application Publication
(10) Pub. No.: US 2015/0283961 A1
(43) Pub. Date: Oct. 8, 2015

(54) BADGE ASSEMBLY FOR CONNECTION TO AN AIRBAG COVER, COVER FOR AIRBAG MODULE, AIRBAG MODULE AND STEERING WHEEL COMPRISING SUCH BADGE ASSEMBLY

(71) Applicant: Dalphi Metal Espana S.A., Vigo (ES)

(72) Inventor: Luis Walter Barreiro Garcia, Vigo (ES)

(21) Appl. No.: 14/676,946

(22) Filed: Apr. 2, 2015

(30) Foreign Application Priority Data
Apr. 4, 2014 (DE) 202014002912.1

(51) Int. Cl. B60R 13/10

(52) U.S. Cl. CPC B60R 13/105

(57) ABSTRACT

The invention relates to a badge assembly for connection to an airbag cover, especially a front plate (30) of the airbag cover, comprising a badge (10) and a retaining plate (20) adapted to be connected to each other by clipping, wherein the retaining plate (20) has at least one material weakening forming a defined breaking or bending line (21) and wherein the badge (10) is breakable or bendable so that the badge (10) jointly with the retaining plate (20) breaks along the defined breaking line into at least two parts or bends along the defined bending line (21) upon opening of the airbag cover. The invention further relates to a cover for an airbag module, an airbag module and a steering wheel for a multitrack ground vehicle comprising such badge assembly.

### BACKGROUND OF THE INVENTION

The invention relates to a badge assembly for connection to an airbag cover and further deals with a cover for an airbag module, an airbag module as well as a steering wheel for a multitrack ground vehicle each having such badge assembly.

In practice badge assemblies are known which are arranged, for example, on an airbag cover of a vehicle steering wheel. Badge assemblies of this type comprise a badge visible to the driver or occupant of the ground vehicle and usually providing an indication of the car manufacturer. So far the badge is usually in the form of a car manufacturer's logo. One or more counter-pieces connectable to the badge usually serve for fastening the badge to the airbag cover so that the airbag cover is clamped between the badge and the counter-piece. The connection between the badge and the counter-piece can be made by riveting or by a click-stop connection.

The guiding of predetermined breaking lines in the cover is comparatively complicated due to the badge being mounted on the cover. Such predetermined breaking lines are required to have the cover break in a well-directed manner, when an airbag is activated in the case of crash and inflates explosively. In some cases it has been considered to guide the predetermined breaking lines around the badge and the badge assembly, resp., which results in opening halves of the cover of unequal size. The unequally shaped halves of the cover behave differently upon opening of the airbag, whereby additional costs are incurred in designing such airbag cover.

Most of the known badge assemblies are welded to the cover or fixed thereto by bending over its respective metal attachment feet. Such previously employed techniques for connecting the emblem to the airbag cover require increased manufacturing costs.

### SUMMARY OF THE INVENTION

It is the object of the invention to state a badge assembly for connection to an airbag cover which is easy to mount and safely and undetachably connected, even during initiation of the air bag. Another object of the invention consists in indicating a cover for an airbag module, an airbag module and a steering wheel, each including such badge assembly.

In accordance with the invention, this object is achieved by the subject matter of claims 1 and 2 as regards the badge assembly, by the subject matter of claim 9 as regards the cover, by the subject matter of claim 14 as regards the airbag module and by the subject matter of claim 15 as regards the steering wheel.

The invention is based on the idea to state a badge assembly for connection to an airbag cover, especially a front plate of the airbag cover. According to a first inventive concept, the badge assembly comprises a badge and a retaining plate adapted to be connected to each other by clipping. The retaining plate includes at least one material weakening, the material weakening forming a defined breaking iine and the badge being breakable such that the badge jointly with the retaining plate breaks into at least two parts along the defined breaking line upon opening of the airbag cover.

According to a second inventive concept, tbe badge assembly comprises a badge and a retaining plate adapted to be connected to each other by clipping. The retaining plate includes at least one material weakening, the material weakening forming a defined bending line and the badge being bendable such that the badge jointly with the retaining plate bends along the defined bending line upon opening of tbe airbag cover without breaking apart.

The badge assembly according to the invention can be mounted especially easily as relatively few component parts are required. The badge assembly substantially comprises the badge and a retaining plate, the connection between the badge and the retaining plate being made by simple clipping. Moreover, according to the first inventive concept, the retaining plate includes a material weakening forming a defined breaking line. In this way the badge assembly can be arranged in the area of predetermined breaking lines of the airbag cover, which improves the design variety of airbag covers. This is assisted by the fact that the badge itself is breakable so that the badge breaks jointly with the retaining plate. A predetermined breaking line of the airbag cover hence can extend across the badge assembly, wherein opening of the airbag cover upon activation of the airbag continues to be easily possible. Furthermore, the invention allows designing the parts of the airbag cover separating from each other for opening in a similar geometry, thereby the design of the airbag cover being facilitated. Complicated bypassing of the badge by predetermined breaking lines guided in a complicated manner can be dispensed with.

Also, the badge assembly according to the second inventive concept can be mounted easily as only few parts and assembly steps are required. The badge assembly substantially comprises the badge and a retaining plate, the connection between the badge and the retaining plate being made by simple clipping. Moreover, according to the second inventive concept, the retaining plate includes a material weakening forming a defined bending line. In this way the badge assembly can be arranged in the area apart from or distant of predetermined breaking lines of the airbag cover, which improves the design variety of airbag covers. This is assisted by the fact that the badge itself is bendable so that the badge and the retaining plate do not break jointly with the cover. A predetermined breaking line of the airbag cover hence can extend apart or distant from the badge assembly, wherein opening of the airbag cover upon activation of the airbag continues to be easily possible. Furthermore, the invention allows a positioning of the badge assembly at parts of the airbag cover which bent itself when opening during deployment of the airbag. As the badge assembly is designed to be bendable, any undesired breaking off of parts of the badge assembly can be avoided, thereby the design of the airbag cover being facilitated. Complicated arrangement of the badge along predetermined breaking lines in a complicated manner can be dispensed with.

In a preferred configuration of the invention it is provided that the badge has a substantially constant thickness and/or is designed free from predetermined breaking lines. In other words, although the badge is breakable or breakable (according to the respective embodiment or concept), it has no defined predetermined breaking lines, however. In particular, the badge can be formed of a plastic material. The plastic material can be additionally provided with a decorative design layer, for example a chromium layer.

In another special configuration of the badge assembly according to the invention, the badge and the retaining plats are breakable in a substantially splinter-proof manner. In this way individual splinters of the badge assembly are prevented from moving across an occupant compartment like a shot upon breakup of the airbag cover and from increasing the risk of injury for vehicle occupants. Rather, it is advantageously provided that each of the badge and the retaining plate breaks into two or more predefined parts, wherein clear and smooth bending edges are formed. The bending edges are orientated at the bending line in the retaining plate. Preferably the badge can break in such way that it breaks along the material weakening of the retaining plate without exhibiting inherent predetermined bending lines.

As regards the connection between the badge and the retaining plate, it is preferably provided that it is non-detachable. Thus, on the one hand, an especially good fixation of the badge assembly on an airbag cover is achieved and inadvertent detaching upon opening the airbag cover is avoided. On the other hand, the non-detachable connection between the badge and the retaining plate also prevents theft. The badge preferably is not separable from the retaining plate without being destroyed. Rather, the badge and/or the retaining plate have to be damaged so as to separate the badge and the retaining plate from each other.

The retaining plate can have plural clip acceptances arranged outside the material weakenings. The clip acceptances permit fixing the badge to the retaining plate. The arrangement of the clip acceptances outside the material weakenings increases the stability of the clip connection.

In preferred embodiments the badge includes a decoration member and one or more clip extensions which are formed integrally with the decoration member. Within the scope of the present application, the badge part visible to a vehicle occupant, usually a car manufacturer's logo, is referred to as decoration member. Clip extensions which in the mounted state of the badge assembly protrude into the retaining plate, especially engage in the clip acceptances, are connected to this decoration member. The clip connection between the badge and the retaining plate is preferably made by engaging the clip extensions of the badge in the clip acceptances of the retaining plate.

In a preferred configuration of the invention each of the clip projections has a distance portion so that in the state clip-connected to the retaining plate a lower side of the badge is arranged spaced apart from the upper side of the retaining plate. Thus a defined distance exists between the badge and the retaining plate. This distance can serve for receiving a front plate of the airbag cover. The front plate of the airbag cover in this way can be clamped between the badge and the retaining plate, thereby the badge assembly being appropriately fixed to the airbag cover.

The badge moreover may have one central clip extension and plural off-center clip extensions, the central clip extension having a circular cross-sectional profile and the off-center clip extensions having a substantially oval cross-sectional profile. The off-center clip extensions having an oval cross-sectional profile fix the badge to the retaining plate in a substantially torsion-proof manner. On the other hand, it is advantageous to design the central clip extension to be circular, thereby the alignment of the badge with the retaining plate being facilitated. Especially the central clip extension further may have a larger length than the off-center clip extensions. Therefore, during mounting of the badge the central clip extension can first engage in the retaining plate. In this way a temporary rotatable connection is made between the badge and the retaining plate so that by rotating the badge the alignment of the off-center clip extensions with corresponding off-center clip acceptances in the retaining plate is enabled. As soon as the off-center clip extensions are aligned with the off-center clip acceptances, by movement between the badge and the retaining plate toward each other the off-center clip extensions can be clipped into the off-center clip acceptances. Then the badge is connected to the retaining plate in the desired alignment.

As regards the alignment of the badge assembly relative to the airbag cover, the retaining plate is preferably configured to have a substantially circular outer contour with a flattened side. Accordingly, for example the front plate of the airbag cover can comprise a recess corresponding to the outer contour of the retaining plate. In this way the retaining plate can be arranged at the airbag cover only at an orientation defined before. Due to the defined alignment between the badge and the retaining plate the defined alignment between the retaining plate and the airbag cover in total also allows a correct alignment between the badge and the airbag cover. This ensures that the badge is arranged at the airbag cover with the desired orientation.

An independent aspect of the invention relates to a cover for an airbag module, consequently an airbag cover, comprising an afore-described badge assembly. It is provided in a preferred configuration that a front plate of the cover is arranged between the badge and the retaining plate. In particular, the clip extensions of the badge can extend through the front plate, especially through apertures provided in the front plate. In addition, the material weakening of the retaining plate may be configured to be aligned along a predetermined bending line of the cover, in particular along a predetermined bending line of the front plate. The badge assembly thus can be arranged exactly in the area of a predetermined bending line of the cover. Nevertheless it is further ensured due to the bending line defined by the material weakening and the breakable badge that the cover appropriately opens upon deployment of an airbag.

Another independent aspect of the invention relates to an airbag module comprising an afore-described badge assembly and/or an afore-described cover. Finally the invention deals also deals with a steering wheel for a multitrack ground vehicle, the steering wheel comprising the badge assembly and/or the cover and/or the afore-mentioned airbag module.

### BRIEF DESCRIPTION OF THE DRAWINGS

Hereinafter the invention shall be illustrated in detail by way of embodiments with reference to the enclosed schematic drawings in which:

FIG. 1 shows a cross-sectional view of a detail of a badge assembly according to the invention in accordance with a preferred embodiment in the mounted state on an airbag cover;

FIG. 2 shows a top view of a retaining plate of the badge assembly according to FIG. 1;

FIG. 3 shows a detailed view of the retaining plate according to FIG. 2;

FIG. 4 shows a sectional view of the detail according to FIG. 3 along the line F-F;

FIG. 5 shows a top view of a badge of the badge assembly according to FIG. 1;

FIG. 6 is a sectional view of the badge according to FIG. 5 along the line B-B; and

FIG. 7 shows a detailed view of the badge according to FIG. 5.

### DESCRIPTION

In FIG. 1 a section across a badge assembly in the mounted state is shown. The badge assembly comprises a badge 10 and a retaining plate 20 connected to each other by clipping. A front plate 30 of an airbag cover extends between the retaining plate 20 and the badge 10. The front plate 30 is fixed by clamping substantially between the badge 10, especially a decoration member 11 of the badge 10, and the retaining plate 20. The front plate 30 comprises an aperture 31 through which the badge 10, especially a clip extension 12 of the badge 10, extends. Moreover, it is visible in FIG. 1 that the front plate 30 includes a recess 32 in which the decoration member 11 of the badge 10 is embedded. It is achieved in this way that the decoration member 11 does not project from the front plate 30, which on the one hand serves for a better appearance of the front plate 30 and, on the other hand, for reducing the risk of injury.

The badge 10 comprises the decoration member 11 and clip extensions 12 integrally formed at the decoration member 11. In the cross-section according to FIG. 1 it is clearly visible that the clip extension 12 has a plurality of portions. A distance portion 13 keeping the decoration member 11 spaced apart from the retaining plate 20 is directly connected to the decoration member 11. In particular, the distance portion 13 ensures that a lower side 19 of the badge 10 remains spaced apart from an upper side 26 of the retaining plate 20. The distance portion 13 comprises a shoulder 16 which is transformed into a neck 15. In the transition from the shoulder 16 to the neck 15 the clip extension 12 is tapered. A head 14 whose cross-sectional diameter substantially corresponds to the cross-sectional diameter of the shoulder 16 is connected to the neck 15. On Its outer periphery the neck 15 forms a slide surface 18 which is inwardly curved starting from the shoulder 16 toward the head 15. At right angles a stop face 17 is connected to the slide surface 18. The stop face 17 extends substantially perpendicularly to a longitudinal axis of the clip extension 12.

The retaining plate 20 comprises a clip acceptance 22 including plural elastic fingers 23. The fingers 23 are curved from the upper side 26 of the retaining plate 20 toward a rear side 29. The curvature of the fingers 23 substantially corresponds to the curvature of the slide surface 18 at the clip extension 12. Furthermore, the fingers 23 include an end face 24 which in the connected state with the badge 10 is adjacent to the stop face 17 of the clip extension 12. The respectively opposed fingers 23 are flexibly outwardly movable in the axial direction of the clip extensions 12 by a pressing movement of the badge. Especially the head 14 of the clip extension 12 forces the fingers 23 substantially radially outwardly during the joining movement between the badge 10 and the retaining plate 20. As soon as the fingers 23 have reached the area of the neck 15, the elastic resetting force of the fingers 23 causes the fingers 23 to be urged radially inwardly and in this way to engage in the recess formed by the tapered neck 15. The end face 24 abutting against the stop face 17 prevents the clip extension 12 from being withdrawn from the clip acceptance 22. Thus the badge 10 is non-detachably connected to the retaining plate 20. In other words, a non-destructive separation of the badge 10 and the retaining plate 20 is impossible.

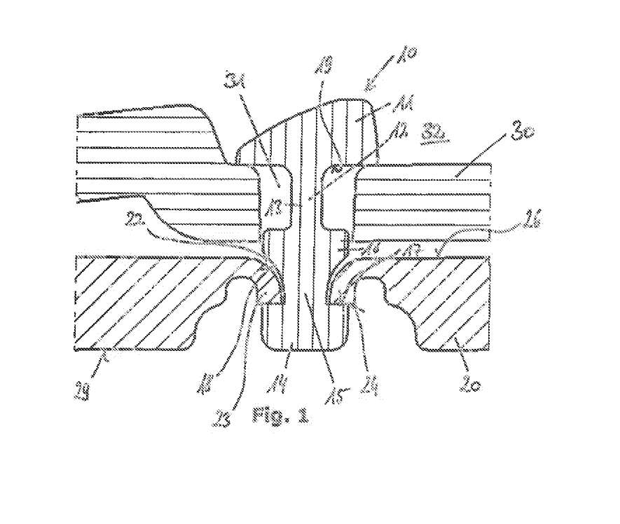

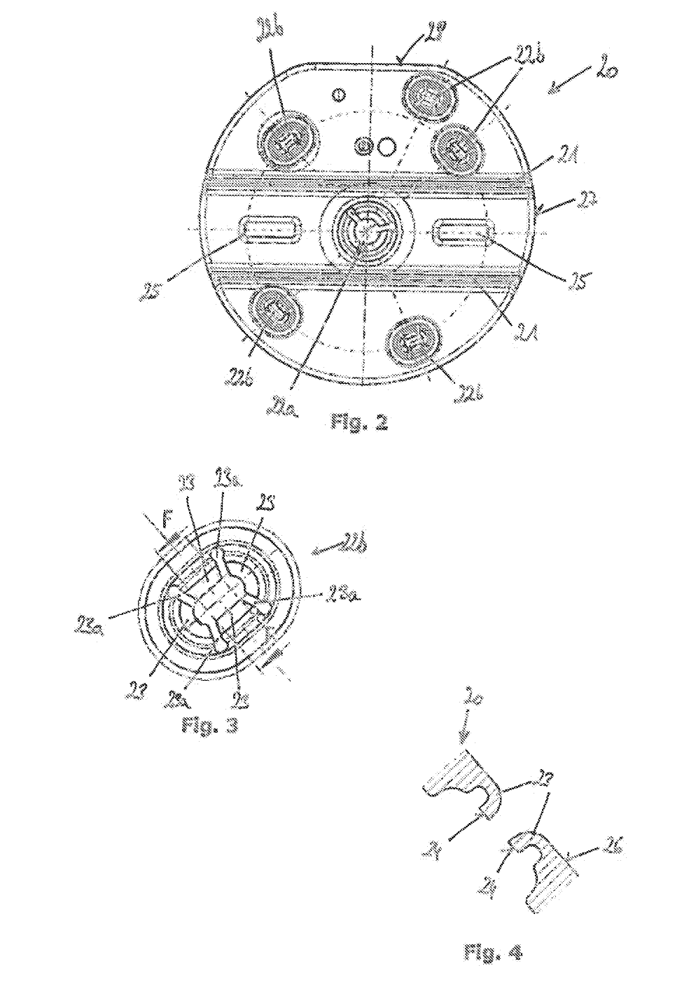

In FIG. 2 a top view of the retaining plate 20 is shown. It is visible that the retaining plate 20 includes plural clip acceptances 22 with one central clip acceptance 22a and plural off-center clip acceptances 22b being provided. The clip acceptances are arranged in total outside material weakenings, especially outside breaking/bending lines 21. It is further evident that the off-center clip acceptances 22b are irregularly arranged in the retaining plate. In this way it is achieved that only one single orientation between the badge 10 and the retaining plate 20 permits tight connection between the badge 10 and the retaining plate 20. The off-center clip acceptances 22b have a substantially oval contour for receiving clip extensions 12 having an oval cross-sectional profile.

The central clip acceptance 22a in total comprises three fingers 23 substantially forming a circular acceptance for a correspondingly circular clip extension 12. The central clip acceptance 22a substantially forms a pivot bearing for a rotating alignment of the badge 10 relative to the retaining plate 20. Especially the badge 10 has corresponding clip extensions 12, with a central clip extension 12a having a larger length than the off-center clip acceptances 12b. This results in the fact that with the connection between the retaining plate 20 and the badge 10 first the central clip extension 12a engages in the central clip acceptance 22a. Then the badge 10 is connected to the retaining plate 20, although it continues to be rotatable vis-à-vis the retaining plate 20. In this way tbe correct orientation for the badge 10 relative to the retaining plate 20 can be easily found so as to connect the off-center clip acceptances 12b to the off-center clip acceptances 22b when the joining movement is continued.

It is further evident from FIG. 2 that the retaining plate 20 has two straight material weakenings extending transversely across the retaining plate 20. Said material weakenings preferably form breaking or bending lines 21. The breaking lines 21 completely pass through the retaining plate so that the retaining plate 20 can completely break in two along at least one of the breaking lines 21. The breaking lines 21 or material weakenings are adapted so that a splinter-proof breaking occurs.

According to the second alternative of the invention, the bending lines 21 completely pass through the retaining plate so that the retaining plate 20 can bend in a predetermined desired manner along at least one of the bending lines 21. The bending lines 21 or material weakenings are adapted so that no breaking occurs.

Moreover, two positioning apertures 25 are evident between the breaking/bending lines 21. The positioning apertures 25 exhibit a substantially rectangular contour. The positioning apertures 25 and corresponding positioning pins at the front plate 30 of the airbag cover enable the exact positioning of the retaining plate 20.

Furthermore, the outer contour of the retaining plate 20 serves as positioning aid. For this purpose, the retaining plate 20 has a substantially circular outer contour 27, the outer contour 27 comprising a flattened side 28. In the front plate 30 preferably a corresponding recess is provided which is equally circular and has a flattened side. In this way the retaining plate 20 can be arranged only at one single orientation relative to the front plate 30. In connection with the irregularly arranged off-center clip acceptances 22a the configuration of the retaining plate 20 enables the badge 10 to be exactly aligned relative to the front plate 30.

In FIG. 3 an off-center clip acceptance 22b is shown in detail. It is evident that the off-center clip acceptance 22b has a substantially oval aperture contour. The off-center clip acceptance 22b comprises four fingers 23, wherein two diametrically opposed fingers 23 are circular arc-shaped. Two further diametrically opposed fingers 23 substantially exhibit a straight shape. Between the individual fingers 23 slits 23a ensuring sufficient freedom of movement of the elastic fingers 23 are provided.

FIG. 4 shows a section across the off-center clip acceptance 22b according to FIG. 3. The two diametrically opposed fingers 23 each of which includes an end face 24 are clearly visible. The fingers 23 are transformed substantially flush into the upper side 26 of the retaining plate 20.

FIG. 5 illustrates a top view of a badge 10. The badge 10 comprises plural clip extensions 12, with one central clip extension 12a and plural off-center clip extensions 12b being provided. The off-center clip extensions 12b are substantially arranged on a circular line around the center of the badge 10. The distance between the off-center clip extensions 12b along the circular line is different so that in total an irregular arrangement of the off-center clip extensions 12b is resulting. The central clip extension 12a is arranged centrally in the badge 10 and has a substantially circular cross-sectional contour. As explained in the foregoing already, the central clip extension 12a is preferably longer than the off-center clip extensions 12b so that the central clip extension 12a engages in the central clip acceptance 22a for pre-positioning the badge 10 relative to the retaining plate 20 and enables the badge 10 to rotate vis-à-vis the retaining plate 20. In this manner, the off-center clip extensions 12b can be aligned relative to the off-center clip acceptances 22b.

FIG. 6 illustrates a section across the badge 10 along the line B-B. The badge generally includes a decoration member 11. The off-center clip extension 12b is integrally formed with the decoration member 11. The off-center clip extension 12b and generally the clip extensions 12 of the badge 10, resp., comprise a distance portion 13, a neck 15 and a head 14. Moreover, a shoulder 16 is arranged at the distance portion 13. Starting from the shoulder 16 a slide surface 18 extends in curved shape toward the head 14. The curved slide surface 18 forms the tapered neck 15 of the clip extension 12. The slide surface 18 abuts against a stop face 17 extending substantially at right angles to the slide surface 18 and/or to the longitudinal axis of the clip extension 12. The stop face 17 forms a lower side of the head 14.

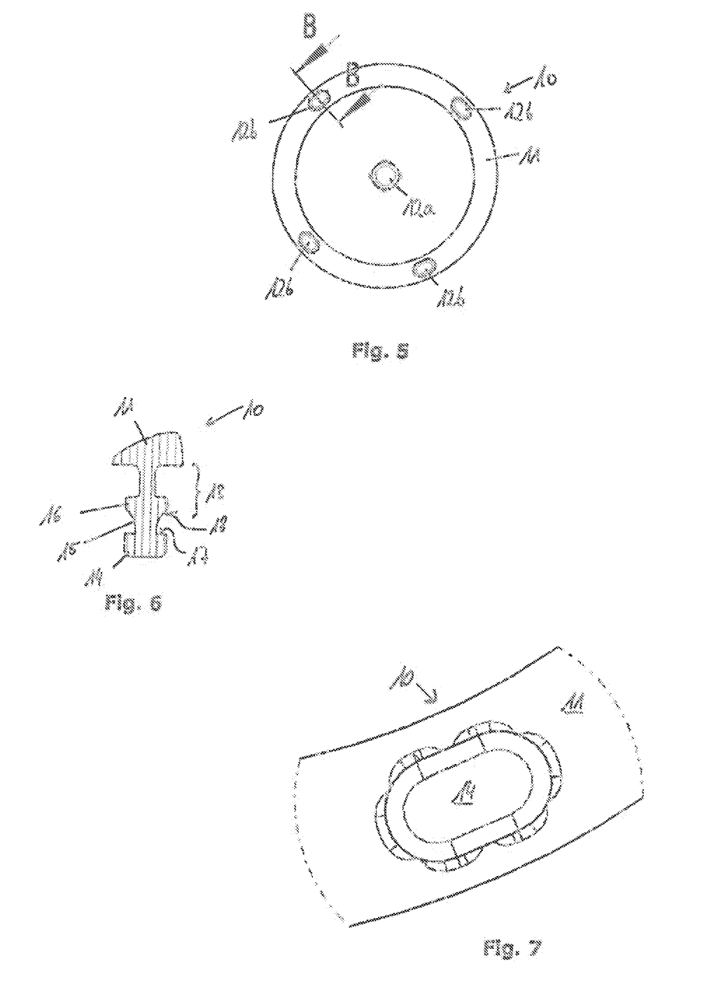

In FIG. 7 the off-center clip extension 12b is shown in a top view. The decoration member 11 and the head 14 of the off-center clip extension 12b are evident. It is also clearly visible that the head 14 has a substantially oval cross-sectional contour. The cross-sectional contour of the off-center clip extension 12b in general corresponds to the cross-sectional contour of the off-center clip acceptance 12 in the retaining plate 20.

### LIST OF REFERENCE NUMERALS

10 badge
11 decoration member
12 clip extension
12a central clip extension
12b off-center clip extension
13 distance portion
14 head
15 neck
16 shoulder
17 stop face
18 slide surface
19 lower side
20 retaining plate
21 breaking/bending line
22 clip acceptance
22a central clip acceptance
22b off-center clip acceptance
23 finger
23a slit
24 end face
25 positioning aperture
26 upper side
27 outer contour
28 flattened side
29 rear side
30 front plate
31 aperture
32 recess

1. A badge assembly for connection to an airbag cover, especially a front plate (30) of the airbag cover, comprising a badge (10) and a retaining plate (20) adapted to be connected to each other by clipping, the retaining plate (20) including at least one material weakening, wherein the latter forms a defined breaking line (21) and wherein the badge (10) is breakable so that the badge (10) jointly with the retaining plate (20) breaks into at least two parts along the defined breaking line (21) upon opening of the airbag cover, wherein the badge (10) and the retaining plate (20) are breakable in a substantially splinter-proof manner.

2. A badge assembly for connection to an airbag cover, especially a front plate (30) of the airbag cover, comprising a badge (10) and a retaining plate (20) adapted to be connected to each other by clipping, the retaining plate (20) including at least one material weakening, wherein the latter forms a defined bending line (21) and wherein the badge (10) is bendable so that the badge (10) jointly with the retaining plate (20) can bend along the defined bending line (21) upon opening of the airbag cover without being broken.

3. The badge assembly according to claim 1, wherein the badge (10) has a constant thickness and/or is formed to be free from predetermined bending lines, and/ or in that the clip connection between the badge (10) and the retaining plate (20) is non-detachable.

4. The badge assembly according to claim 1, wherein the badge assembly contains exactly one badge (10) and exactly one retaining plate (20), wherein the badge includes plural clip extensions (12) and the retaining plate (20) includes plural clip acceptances (22), wherein preferably the clip acceptances (22) are arranged outside the material weakenings.

5. The badge assembly according to claim 1, wherein the badge (10) includes a decoration member (11) and one or more clip extensions (12) which are integrally formed with the decoration member (11).

6. The badge assembly according to claim 6, wherein each of the clip extensions (12) has a distance portion (13) so that a lower side (19) of the badge (10) is arranged to be spaced apart from an upper side (26) of the retaining plate (20) in the state clip-connected to the retaining plate (20).

7. The badge assembly according to claim 6, wherein the badge (10) includes a central clip extension (12a) and plural off-center clip extensions (12b), the central clip extension (12a) exhibiting a circular cross-sectional profile and the off-center clip extensions (12b) exhibiting a substantially oval cross-sectional profile.

8. The badge assembly according to claim 1, wherein the retaining plate (20) has a substantially circular outer contour (27) including a flattened side (28).

9. A cover for an airbag module comprising a badge assembly according to claim 1.

10. The cover according to claim 9, wherein a front plate (30) of the cover is arranged between the badge (10) and the retaining plate (20).

11. The cover according to claim 9, wherein the clip extensions (12) of the badge (10) extend through the front plate (30), especially through apertures (31) provided in the front plate (30).

12. The cover according to claim 9, wherein the material weakening of the retaining plate (20) is aligned along a predetermined bending line of the cover, especially of the front plate (30).

13. The cover according to claim 9, wherein the material weakening of the retaining plate (20) is positioned at a distance from predetermined bending lines of the cover, especially of the front plate (30).

14. An airbag module comprising a badge assembly and/or a cover according to claim 1.

15. A steering wheel for a multitrack ground vehicle comprising a badge assembly and/or a cover and/or an airbag module according to claim 1.
